(19) United States
(12) Patent Application Publication
(10) Pub. No.: US 2013/0264047 A1
(43) Pub. Date: Oct. 10, 2013

(54) SHIELDED POSITIVE STOPS FOR AN ACTIVE SHUTTER

(71) Applicants: Scott P. Charnesky, Birmingham, MI (US); John C. Remy, Shelby Township, MI (US); Brian D. Van Buren, Shelby Township, MI (US)

(72) Inventors: Scott P. Charnesky, Birmingham, MI (US); John C. Remy, Shelby Township, MI (US); Brian D. Van Buren, Shelby Township, MI (US)

(73) Assignee: GM GLOBAL TECHNOLOGY OPERATIONS LLC, Detroit, MI (US)

(21) Appl. No.: 13/442,916

(22) Filed: Apr. 10, 2012

(51) Int. Cl. B60H 1/26; B60H 1/32; G05D 23/00

(52) U.S. Cl. 165/287; 454/152; 165/41

(57) ABSTRACT

A shutter system for controlling airflow through a grille opening in a vehicle includes a shutter housing. The shutter system also includes a louver supported by and configured to rotate relative to the shutter housing about a pivot axis. The shutter system also includes a first positive stop configured to prevent the louver from rotating past a fully-opened position and a second positive stop configured to prevent the louver from rotating past a fully-closed position. The shutter system additionally includes a shield arranged relative to the shutter housing and configured to screen the first and second positive stops from the airflow and protect the positive stops from airborne dirt and debris. A vehicle having the above shutter system is also disclosed.

### TECHNICAL FIELD

The disclosure relates to shielded positive stops for an active or adjustable shutter.

### BACKGROUND

A shutter is typically a solid and stable covering for an opening. A shutter frequently consists of a frame and louvers or slats mounted within the frame.

Louvers may be fixed, i.e., having a permanently set angle with respect to the frame. Louvers may also be operable, i.e., having an angle that is adjustable with respect to the frame for permitting a desired amount of light, air, and/or liquid to pass from one side of the shutter to the other. Depending on the application and the construction of the frame, shutters can be mounted to fit within, or to overlap the opening. In addition to various functional purposes, particularly in architecture, shutters may also be employed for largely ornamental reasons.

In motor vehicles, a shutter may be employed to control and direct a stream of air to various vehicle compartments and/or subsystems. Particularly, a shutter may be positioned at the front of the vehicle and employed to cool a vehicle's powertrain, as well as enhance comfort of vehicle passengers.

### SUMMARY

A shutter system for controlling airflow through a grille opening in a vehicle includes a shutter housing. The shutter system also includes a louver supported by and configured to rotate relative to the shutter housing about a pivot axis. The shutter system also includes a first positive stop configured to prevent the louver from rotating past a fully-opened position and a second positive stop configured to prevent the louver from rotating past a fully-closed position. The shutter system additionally includes a shield arranged relative to the shutter housing and configured to screen the first and second positive stops from the airflow and protect the positive stops from airborne dirt and debris.

The shutter housing may include a side section configured to support one end of the louver. In such a case, the shield may be attached to the side section and the first and second positive stops may be arranged within the side section.

The shutter system may also include an actuation mechanism configured to rotate the louver about the pivot axis in order to select between and inclusive of the fully-opened and fully-closed positions of the louver.

The louver may include a plurality of louvers. The actuation mechanism may then be configured to rotate the plurality of louvers in tandem.

The shutter system may additionally include a controller configured to regulate the actuation mechanism.

The plurality of louvers may be arranged as a side-by-side pair of louvers. In such a case, the shutter housing may include an intermediate section configured to support one end of each louver. Additionally, the shield may be attached to the intermediate section and the first and second positive stops may be arranged within the intermediate section.

The shield may be integrally formed with the shutter housing.

The vehicle may include an internal combustion engine and the controller may be configured to regulate the actuation mechanism according to a load on the engine.

The vehicle engine may be cooled by a fluid circulated through a heat exchanger. In such a case, the vehicle may also include a sensor adapted to sense a temperature of the fluid and configured to communicate the temperature to the controller.

The controller may be configured to regulate the actuation mechanism to cool the fluid circulated through the heat exchanger according to the sensed temperature of the fluid.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a partial perspective view of a vehicle having a shutter system with rotatable louvers having positive stops shielded from airborne dirt and debris, with the louvers being depicted in a fully-closed state.

FIG. 2 is a partial perspective view of the vehicle shutter system shown in FIG. 1, with the louvers being depicted in a partially-closed state.

FIG. 3 is a partial perspective view of the vehicle shutter system shown in FIGS. 1 and 2, with the louvers being depicted in a fully-opened state.

FIG. 4 is a partial perspective view of the vehicle shutter system shown in FIGS. 1-3 according to one embodiment, with the louvers being depicted in a fully-opened state.

FIG. 5 is a partial cross-sectional enlarged top view of the shutter system and the embodiment of shielded positive stops shown in FIG. 4.

FIG. 6 is a partial perspective view of the vehicle shutter system shown in FIGS. 1-3 according to another embodiment, with the louvers being depicted in a fully-opened state.

FIG. 7 is a partial cross-sectional enlarged top view of the shutter system and the embodiment of shielded positive stops shown in FIG. 6.

### DETAILED DESCRIPTION

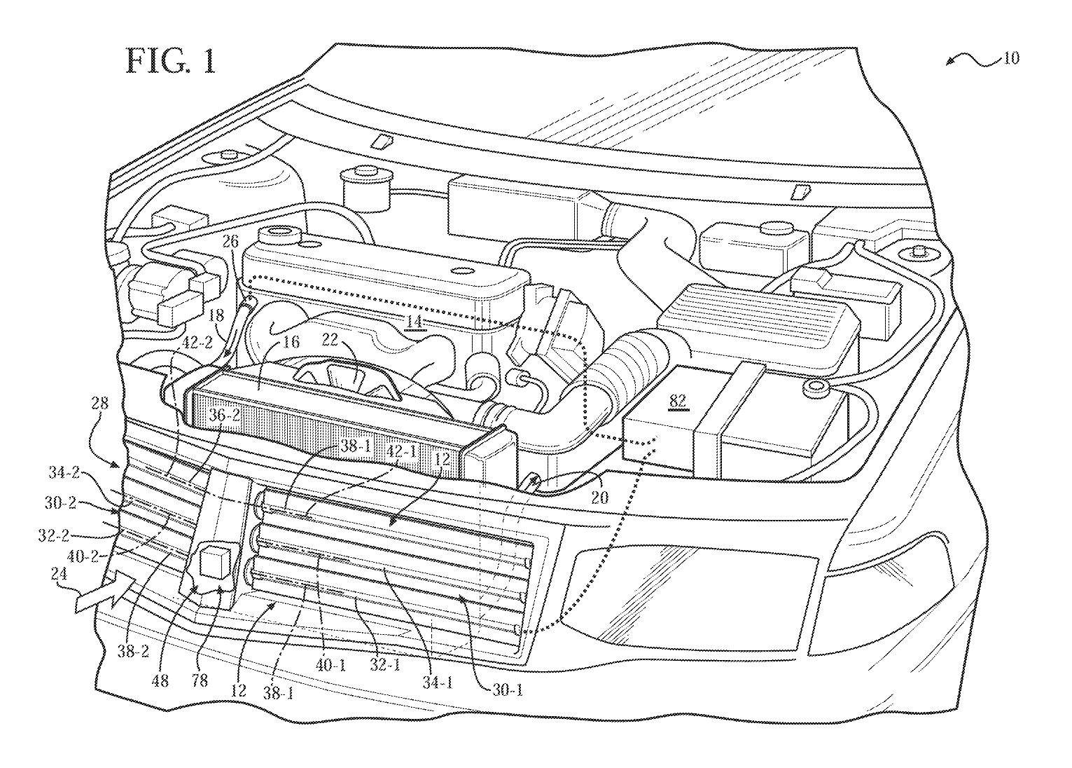

Referring to the drawings, wherein like reference numbers refer to like components, FIGS. 1-3 show a partial perspective view of a vehicle 10. The vehicle 10 is shown to include a grille opening 12 typically covered with a mesh. The grille opening 12 is adapted for receiving ambient air. The vehicle 10 additionally includes a powertrain that is specifically represented by an internal combustion engine 14. The powertrain of the vehicle 10 may additionally include a transmission, and, if the vehicle is a hybrid type, one or more motor-generators, none of which is shown, but the existence of which can be appreciated by those skilled in the art. Efficiency of a vehicle powertrain is generally influenced by its design, as well as by the various loads the powertrain sees during its operation.

The vehicle 10 additionally includes an air-to-fluid heat exchanger 16, i.e., a radiator, for circulating a cooling fluid shown by arrows 18 and 20, such as water or a specially formulated coolant, though the engine 14 to remove heat from the engine. A high-temperature coolant entering the heat exchanger 16 is represented by the arrow 18, and a reduced-temperature coolant being returned to the engine is represented by the arrow 20. The heat exchanger 16 is positioned behind the grille opening 12 for protection of the heat exchanger from various road-, and air-borne debris. The heat exchanger 16 may also be positioned in any other location, such as behind a passenger compartment, if, for example, the vehicle has a rear or a mid-engine configuration, as understood by those skilled in the art.

As shown in FIGS. 1-3, a fan 22 is positioned in the vehicle 10, behind the heat exchanger 16, such that the heat exchanger 16 is positioned between the grille opening 12 and the fan. The fan 22 is capable of being selectively turned on and off based on the cooling needs of the engine 14. Depending on the road speed of the vehicle 10, the fan 22 is adapted to either generate or enhance a flow of ambient air or airflow 24 through the grille opening 12, and toward and through the heat exchanger 16. Thus generated or enhanced through the action of the fan 22, the airflow 24 is passed through the heat exchanger 16 to remove heat from the high-temperature coolant 18 before the reduced-temperature coolant 20 is returned to the engine 14. The vehicle 10 additionally includes a coolant sensor 26 configured to sense a temperature of the high-temperature coolant 18 as it exits the engine 14.

FIGS. 1-3 also depict a shutter system 28 having a rotatable or adjustable shutter 30 configured to be selectively placed into various positions. The shutter 30 is secured in the vehicle 10 and is adapted to regulate the amount of airflow 24 entering or flowing into the vehicle from the ambient through the grille opening 12. As shown, the shutter 30 is positioned behind, and immediately adjacent to the grille opening 12 at the front of the vehicle 10. Additionally, the shutter 30 is positioned between the grille opening 12 and the heat exchanger 16. The shutter 30 may also be incorporated into and be integral with the grille opening 12. The shutter 30 includes a first set of louvers 30-1 and a second set of louvers 30-2.

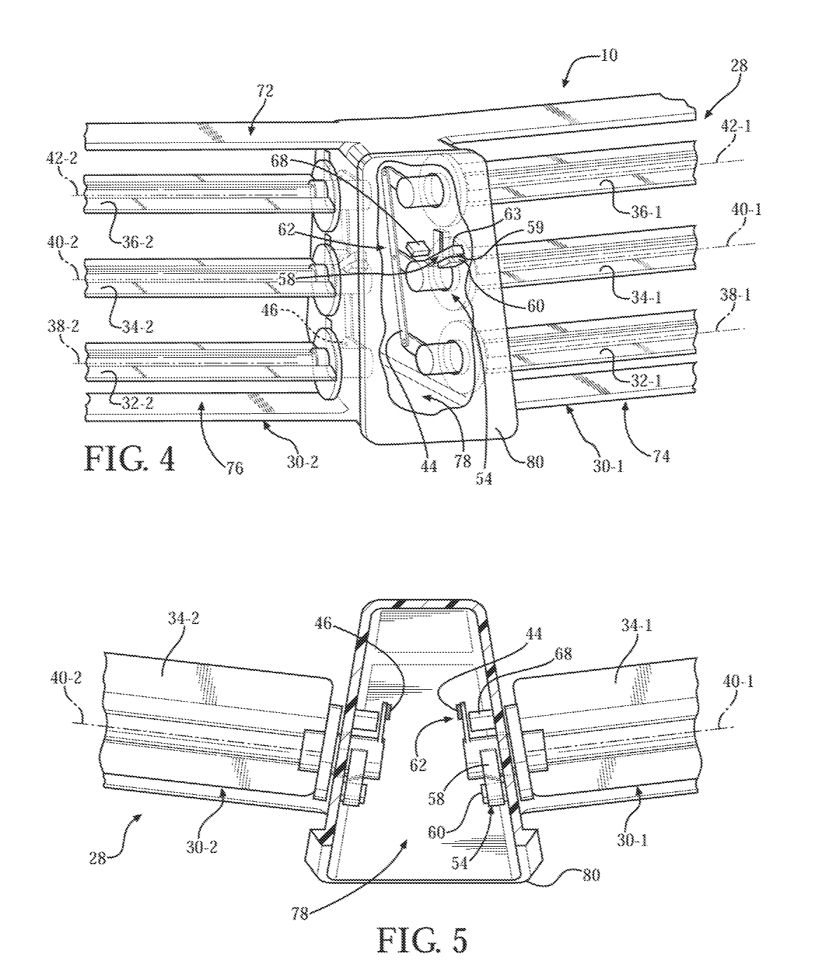

As shown in FIGS. 4-5, each set of louvers 30-1 and 30-2 includes a plurality of louvers. The first set of louvers 30-1 includes three individual louver elements 32-1, 34-1, 36-1, while the second set of louvers 30-2 also includes three individual louver elements 32-2, 34-2, 36-2. Although each louver set 30-1 and 30-2 is shown as having three individual louver elements, the number of louvers in each set may either be fewer or greater. As shown, each respective louver 32-1, 34-1, and 36-1 is paired with each respective louver 32-2, 34-2, and 36-2. Consistent with the possible configuration of the first and second sets of louvers 30-1, 30-2, the number of louvers paired in such fashion within shutter system 28 may be fewer or greater, as required for a specific vehicle application.

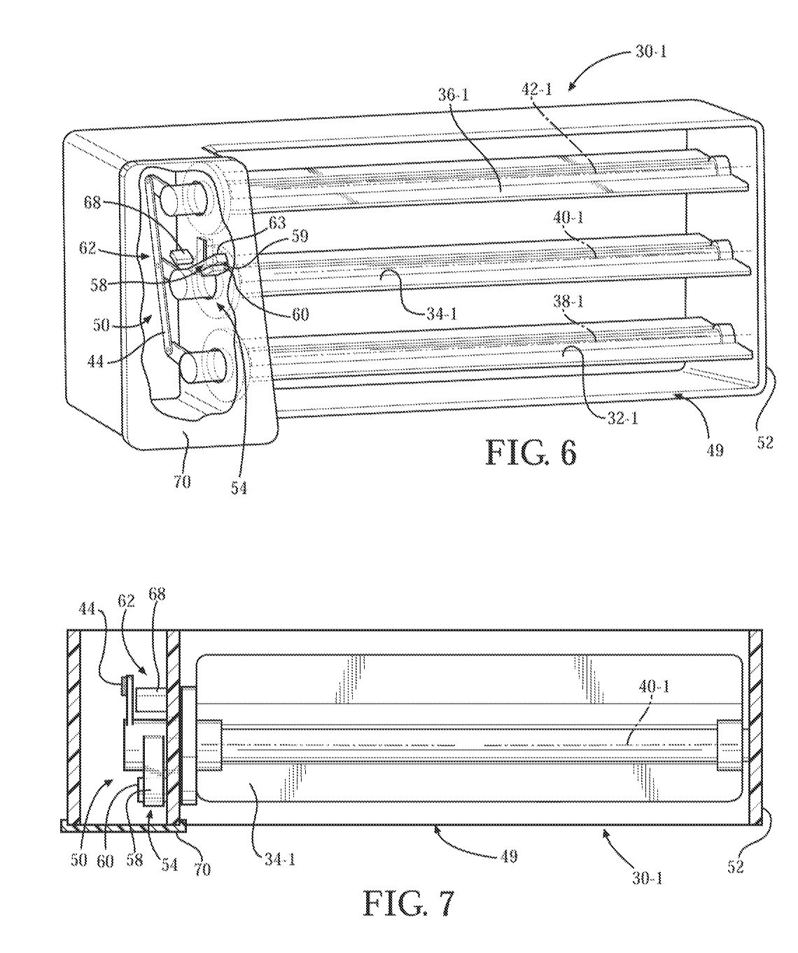

Each louver 32-1, 34-1, 36-1, as well as 32-2, 34-2, 36-2, is configured to rotate about a respective pivot axis 38-1, 40-1, 42-1 and 38-2, 40-2, 42-2 during operation of the shutter 30, thereby effectively controlling the size of the grille opening 12 and the amount of ambient air 24 flowing into the vehicle 10. As shown in FIG. 4, each of the first and second sets of louvers 30-1, 30-2 may include respective separate linkages 44 and 46. Linkages 44 and 46 are configured to rotate louvers 32-1, 34-1, 36-1, and 32-2, 34-2, 36-2 about the respective pivot axes 38-1, 40-1, 42-1 and 38-2, 40-2, 42-2. Additionally, in such a situation the rotation of louvers 32-1, 34-1, 36-1 occurs in tandem, i.e., substantially in unison, via the linkage 44. Similarly, the respective rotation of louvers 32-2, 34-2, 36-2 also occurs in tandem via the linkage 46. Accordingly, simultaneous rotation of the first and second sets of louvers 30-1, 30-2 permits the shutter 30 to rotate into any of the available positions. In addition to the embodiment shown in FIGS. 4 and 5, the shutter 30 may include only one set of louvers, in particular the first set of louvers 30-1, as shown in FIGS. 6-7.

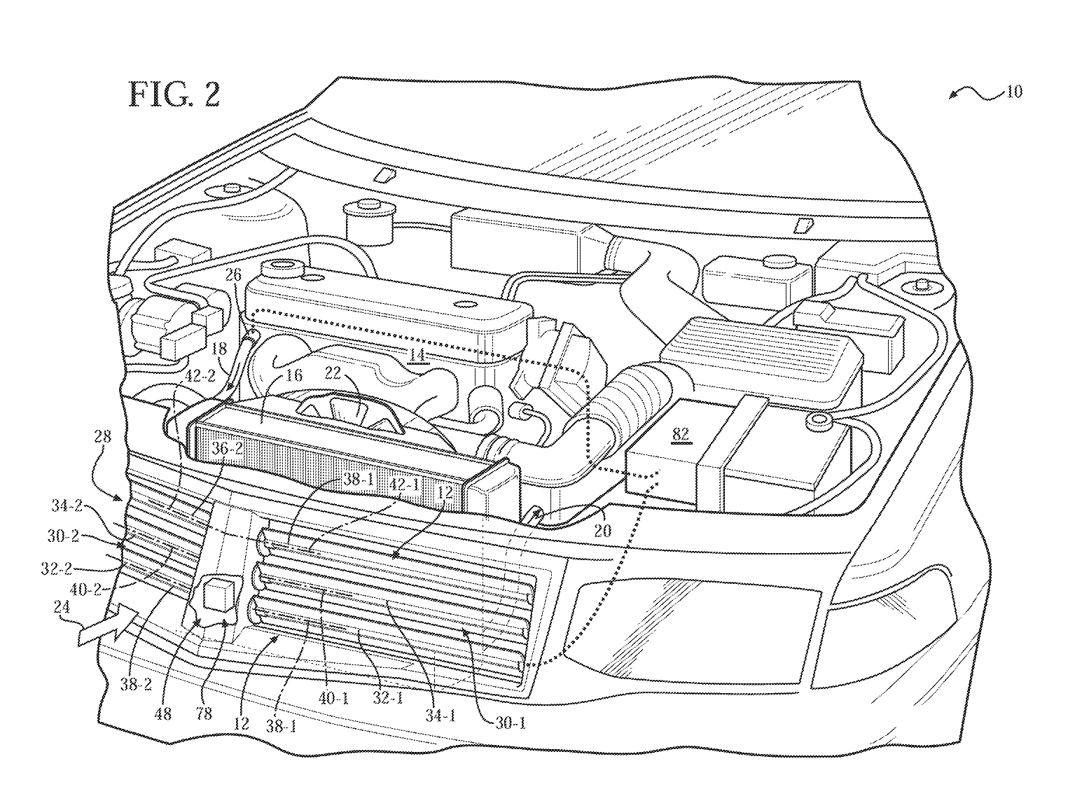

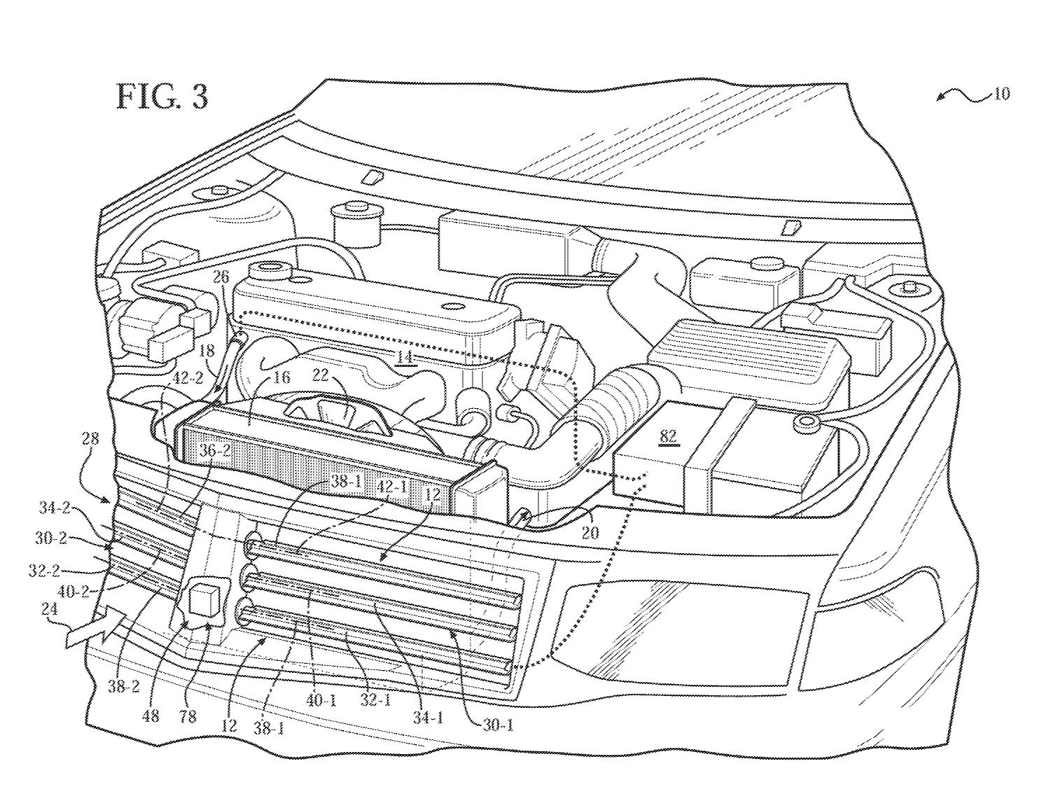

The shutter 30 is adapted to operate between and inclusive of a fully-closed position or state (as shown in FIG. 1), through an intermediate or partially-closed position (as shown in FIG. 2), and to a fully-opened position (as shown in FIG. 3). When the louver elements 32, 34, and 36 are in any of their open positions, the airflow 24 enters the vehicle 10 by penetrating the plane of the shutter 30 before coming into contact with the heat exchanger 16. The shutter system 28 also includes an actuation mechanism 48 configured to rotate the first and second sets of louvers 30-1, 30-2 such that each louver 32-1, 34-1, 36-1, and 32-2, 34-2, 36-2 rotate about the respective pivot axis 38-1, 40-1, 42-1 and 38-2, 40-2, 42-2. The actuation mechanism 48 may include a drive source (not shown), such as an electric motor, configured to supply the drive torque and rotational motion to the louvers of the shutter 30.

As noted above, FIGS. 6-7 depict an embodiment of the shutter 30 that only includes one set of louvers, in particular the first set of louvers 30-1. As shown, each louver 32-1, 34-1, 36-1 is retained in a rigid shutter frame or housing 49. As may additionally be seen from FIG. 6, the housing 49 may include a first side section 50 and a second side section 52, wherein each side section is configured to support one end of each louver. A first positive stop 54 is incorporated into the shutter 30 and configured to prevent the louvers 32-1, 34-1, 36-1 from rotating past a fully-opened position shown in FIG. 6. The first positive stop 54 includes a first surface 59 of a first element 58 arranged on the louver 34-1 and a second element 60, wherein the second element is arranged on the shutter housing 49, specifically within the first section 50.

When the louver 34-1 is rotated to permit a greater amount of airflow 24 to enter the vehicle 10 and reaches its fully-opened position, the first element 58 contacts the second element 60 and limits further rotation of the louver 34-1. Accordingly, the first surface 59 comes into contact with the second element 60 in order to limit the rotation of the louver 34-1 to the fully-opened position. A second positive stop 62 is configured to prevent the louvers 32-1, 34-1, 36-1 from rotating past a fully-closed position. The second positive stop 62 includes a second surface 63 of the first element 58 and a third element 68 arranged in the first section 50 of the shutter housing 49. When the louver 34-1 is rotated to permit a lesser amount of airflow 24 to enter the vehicle 10 and reaches its fully-closed position 64, the second surface 63 of the first element 58 contacts the third element 68 and limits further rotation of the louver 34-1. Accordingly, the second surface 63 of the first element 58 together with the third element 68 limit the rotation of the louver 34-1 to the fully-closed position 64.

The embodiment of shutter 30 shown in FIG. 6 also includes a shield 70 arranged relative to the shutter housing 49 and configured to screen the first and second positive stops 54, 62 from the airflow 24 in order to protect the first and second positive stops from airborne dirt and debris. The shield 70 may be attached to the first side section 50, as shown in FIG. 6, or to the second side section 52. Furthermore, the first and second positive stops 54, 62 are arranged within the side section having the shield 70, particularly, as shown in FIG. 6, within the first side section 50. The shield 70 may be integrally formed with the shutter housing 49 at the first side section 50, such as molded together from a suitably engineered plastic.

In an embodiment of the shutter system 30 shown in FIGS. 4-5, the shutter system includes both the first and second sets of louvers 30-1, 30-2, and the first and second sets of louvers are each retained in a rigid shutter housing 72. As shown, the louvers 32-1, 34-1, 36-1, and 32-2, 34-2, 36-2 are arranged as side-by-side pairs of louvers. In addition to having first and second side sections 74, 76, the housing 72 includes an intermediate section 78 configured to support one end of each louver 32-1, 34-1, 36-1, 32-2, 34-2, and 36-2. The embodiment of the shutter 30 shown in FIGS. 4-5 also includes the first and second positive stops 54, 62. The first positive stop 54 includes the first surface 61 of the first element 58 being arranged on the louver 34-1 and the second, complementary element 60 that is arranged on the shutter housing 72. Additionally, the second positive stop 62 includes the second surface 63 of the first element 58 and the third element 68 that is arranged on the shutter housing 72. As shown, the first and second positive stops 54, 62 are arranged within the intermediate section 78. As shown, the second and fourth elements 60, 68 may be attached directly to the intermediate section, or be arranged on a bracket (not shown) that is configured to mount the actuation mechanism 48 to the shutter housing at the intermediate section 78. The first and second positive stops 54, 62 may be included only on one louver, as described above, on two opposing louvers such as the louvers 34-1 and 34-2 (as shown in FIG. 5), or on as many of the remaining the lovers 32-1, 32-2, 36-1, and 36-2 as deemed necessary for strength and durability of the shutter system 30 in a specific application.

In FIGS. 4-5 the first and second positive stops 54, 62 perform the same function as they do in the embodiment shown and described with respect to FIGS. 6-7. Accordingly, in FIGS. 4-5 the first and second positive stops 54, 62 prevent the louvers 32-1, 34-1, 36-1 from respectively rotating past the fully-opened position 56 and past the fully-closed position 64. The embodiment of the shutter 30 shown in FIGS. 4-5 also includes a shield 80 that may be attached to the intermediate section 78 (as shown in FIG. 1) and configured to screen the first and second positive stops 54, 62 from the airflow 24 in order to protect the first and second positive stops from airborne dirt and debris. Alternatively, and similar to the shield 70 depicted in FIGS. 6-7 and described above, the shield 80 may be integrally formed with the shutter housing 72 at the intermediate section 78, as shown in FIGS. 2-3.

With renewed reference to FIGS. 1-3, the shutter system 28 additionally includes a controller 82 configured to regulate the actuation mechanism 48 to select a desired position for the shutter 30 between and inclusive of fully-opened and fully-closed. Accordingly, for the embodiment of FIGS. 4 and 5, the actuation mechanism 48 is configured to simultaneously select the desired position for both the first and second sets of louvers 30-1, 30-2. The controller 82 may be an engine controller or a separate control unit. The controller 82 may also be configured to operate the fan 22, if the fan is electrically driven, and a thermostat (not shown) that is configured to regulate the circulation of coolant, as understood by those skilled in the art.

The controller 82 is programmed to operate the actuation mechanism 48 according to the load on the engine 14 and, correspondingly, to the temperature of the coolant sensed by the sensor 26. The temperature of the high-temperature coolant 18 is increased due to the heat produced by the engine 14 under load. As known by those skilled in the art, a load on the engine 14 is typically dependent on operating conditions imposed on the vehicle 10, such as going up a hill and/or pulling a trailer. The load on the engine 14 generally drives up the internal temperature of the engine, which in turn necessitates cooling of the engine for desired performance and reliability. Typically, the coolant is continuously circulated by a fluid pump (not shown) between the engine 14 and the heat exchanger 16.

When the shutter 30 is fully-closed, as depicted in FIG. 1, the two sets of louvers 30-1, 30-2 provide blockage of the airflow 24 at the grille opening 12. A fully-closed shutter 30 provides optimized aerodynamics for the vehicle 10 when engine cooling through the grille opening 12 is not required. The shutter 30 may also be operated by the controller 82 to variably restrict access of the oncoming airflow 24 to the heat exchanger 16, by rotating the two sets of louvers 30-1, 30-2 to an intermediate position, as shown in FIG. 2, where the louvers are partially closed. An appropriate intermediate position of the two sets of louvers 30-1, 30-2 is selected by the controller 82 according to a programmed algorithm to thereby affect the desired cooling of the engine 14. When the shutter 30 is fully-opened, as shown in FIG. 3, each of the two sets of louvers 30-1, 30-2 is rotated to a position parallel to the airflow 24 seeking to penetrate the shutter system plane. Thus, a fully-opened shutter 30 is configured to permit a generally unfettered passage of such a flow of air through the louver plane of the shutter 30.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A shutter system for controlling airflow through a grille opening in a vehicle, the shutter system comprising:
a shutter housing;
a louver supported by and configured to rotate relative to the shutter housing about a pivot axis;
a first positive stop including a first element fixed on the louver and a second element fixed on the shutter housing, wherein the first element contacts the second element to prevent the louver from rotating past a fully-opened position;
a second positive stop including the first element fixed on the louver and a third element fixed on the shutter housing, wherein the first element contacts the third element to prevent the louver from rotating past a fully-closed position; and
a shield arranged relative to the shutter housing and configured to screen the first and second positive stops from the airflow.

2. The shutter system of claim 1, wherein:
the shutter housing includes a side section configured to support one end of the louver;
the shield is attached to the side section; and
the first and second positive stops are arranged within the side section.

3. The shutter system of claim 1, further comprising an actuation mechanism configured to rotate the louver about the pivot axis to select between and inclusive of the fully-opened and fully-closed positions.

4. The shutter system of claim 3, wherein the louver includes a plurality of louvers and the actuation mechanism is configured to rotate the plurality of louvers in tandem.

5. The shutter system of claim 4, further comprising a controller configured to regulate the actuation mechanism.

6. The shutter system of claim 4, wherein:
the plurality of louvers is arranged as a side-by-side pair of louvers;
the shutter housing includes an intermediate section configured to support one end of each louver;
the shield is attached to the intermediate section; and
the first and second positive stops are arranged within the intermediate section.

7. The shutter system of claim 5, wherein:
the vehicle includes an internal combustion engine; and
the controller is configured to regulate the actuation mechanism according to a load on the engine.

8. The shutter system of claim 7, wherein the engine is cooled by a fluid circulated through a heat exchanger, and the vehicle includes a sensor adapted to sense a temperature of the fluid and configured to communicate the temperature to the controller.

9. The shutter system of claim 8, wherein the controller is configured to regulate the actuation mechanism to cool the fluid circulated through the heat exchanger according to the sensed temperature of the fluid.

10. The shutter system of claim 1, wherein the shield is integrally formed with the shutter housing.

11. A vehicle comprising:
an internal combustion engine cooled by a circulating fluid;
a heat exchanger configured to cool the fluid via an ambient airflow after the fluid cools the engine;
a grille opening positioned to permit the airflow to pass to the heat exchanger; and
a shutter system for controlling the airflow through the grille opening, the shutter system including:
a shutter housing;
a louver supported by and configured to rotate relative to the shutter housing about a pivot axis;
a first positive stop including a first element fixed on the louver and a second element fixed on the shutter housing, wherein the first element contacts the second element to prevent the louver from rotating past a fully-opened position;
a second positive stop including the first element fixed on the louver and a third element fixed on the shutter housing, wherein the first element contacts the third element to prevent the louver from rotating past a fully-closed position; and
a shield arranged relative to the shutter housing and configured to screen the first and second positive stops from the airflow.

12. The vehicle of claim 11, wherein:
the shutter housing includes a side section configured to support one end of the louver;
the shield is attached to the side section; and
the first and second positive stops are arranged within the side section.

13. The vehicle of claim 11, further comprising an actuation mechanism configured to rotate the louver about the pivot axis to select between and inclusive of the fully-opened and fully-closed positions.

14. The vehicle of claim 13, wherein the louver includes a plurality of louvers and the actuation mechanism is configured to rotate the plurality of louvers in tandem.

15. The vehicle of claim 14, further comprising a controller configured to regulate the actuation mechanism.

16. The vehicle of claim 14, wherein:
the plurality of louvers is arranged as a side-by-side pair of louvers;
the shutter housing includes an intermediate section configured to support one end of each louver;
the shield is attached to the intermediate section; and
the first and second positive stops are arranged within the intermediate section.

17. The vehicle of claim 15, wherein the controller is configured to regulate the actuation mechanism according to a load on the engine.

18. The vehicle of claim 17, further comprising a sensor adapted to sense a temperature of the fluid and configured to communicate the temperature to the controller.

19. The vehicle of claim 18, wherein the controller is configured to regulate the actuation mechanism to cool the fluid circulated through the heat exchanger according to the sensed temperature of the fluid.

20. The vehicle of claim 11, wherein the shield is integrally formed with the shutter housing.
